(19) United States
(12) Patent Application Publication
(10) Pub. No.: US 2021/0344710 A1
(43) Pub. Date: Nov. 4, 2021

(54) SYSTEMS AND METHODS FOR AUTOMATED SIMULATED PHISHING CAMPAIGNS USING NEWSLETTERS

(71) Applicant: KnowBe4, Inc., Clearwater, FL (US)

(72) Inventors: Greg Kras, Dunedin, FL (US); Coda Babani, Palm Harbor, FL (US); Hector Centeno, Dunedin, FL (US); Christine Kipke, Berlin (DE); Rob Henley, Somerville, MA (US)

(21) Appl. No.: 17/242,806

(22) Filed: Apr. 28, 2021

Related U.S. Application Data
(60) Provisional application No. 63/017,821, filed on Apr. 30, 2020.

(51) Int. Cl. H04L 29/06; G09B 19/00; G06F 16/906; G06F 16/908

(52) U.S. Cl. CPC H04L 63/1483; H04L 63/1433; H04L 63/1416; G06F 16/908; G09B 19/00; G06F 16/906; H04L 63/1425

(57) ABSTRACT

Systems and methods are described for classifying email communications as a newsletter type of emails to use in a simulated phishing communication. Initially, one or more emails may be identified to classify as a newsletter type of email. The one or more emails may then be classified as the newsletter type of email based on one or more classification characteristics. An email may be selected from the one or more emails classified as the newsletter type of email. Further, the selected email may be modified to provide a simulated phishing email newsletter. The simulated phishing email newsletter may be communicated to one or more devices of one or more users.

### CROSS-REFERENCE TO RELATED APPLICATION

This application claims priority to and the benefit of U.S. Provisional Patent Application No. 63/017,821, titled “SYSTEMS AMD METHODS FOR AUTOMATED SIMULATED PHISHING CAMPAIGNS USING NEWSLETTERS,” and filed on Apr. 30, 2020, the contents of all of which are hereby incorporated herein by reference in its entirety for all purposes.

### TECHNICAL FIELD

The present solution generally relates to systems and methods for facilitating automated simulated phishing campaigns using newsletters. In particular, the systems and the methods relate to classifying email communications as newsletter type of emails to use in the simulated phishing campaigns.

### BACKGROUND

Phishing attacks are one of the most common security challenges that both individuals and organizations face in keeping their confidential information secure. Phishing attacks exploit human behavior through deception to gain access to organizational systems and personal information of users through electronic means. A phishing attack involves an attempt to acquire sensitive information such as login credentials, bank account information, credit card details, personal data, organization's confidential data, etc., often for malicious reasons, possibly by masquerading as a trustworthy entity. One of the common types of phishing is email phishing. Email phishing involves targeting one or more employees of an organization with malicious intent including covert collection of confidential data using emails. The email phishing involves having message content that appears genuine, personal, or believable and may convince the user to act upon it. A typical phishing email may include a link and/or an attachment of malicious nature. The link when accessed may lead to a webpage that performs malicious actions or tricks the user to provide sensitive information or execute a malicious program. Similarly, the attachment when accessed, may execute a program that performs malicious actions. Malicious actions may be malicious data collection or actions harmful to the normal functioning of a device on which the email was activated, or any other malicious actions capable of being performed by a program or a set of programs.

Organizations have recognized phishing as one of the most prominent threats that can cause a serious breach of data including confidential information. Attackers who launch phishing attacks may attempt to evade an organization's security controls and target its employees. To prevent or to reduce the success rate of phishing attacks on employees, security-conscious organizations may conduct security awareness training programs for their employees, along with other security measures. Through the security awareness training, the organizations actively educate their employees on how to spot and report a suspected phishing attack. As a part of a security awareness training program, an organization may send out simulated phishing emails periodically or occasionally to the devices of the employees and observe responses of the employees to such emails. A simulated phishing email is intended to resemble a real phishing email. The more genuine the simulated phishing email appears, the more likely an employee would respond to that.

Currently organizations do not have mechanisms to conduct security awareness training for malicious newsletter type of email. A newsletter type of email may refer to a publication that may be commonly sent to multiple recipients. The newsletter type of email may include content related to a certain subject, an industry topic, or a particular organization. In some examples, some or all of the content of a malicious newsletter type of phishing email may be of malicious nature. In an example, when a user of an organization receives a malicious newsletter type of email in his or her mailbox, the user may not be able to identify a security threat associated with the malicious newsletter type of email and may interact with it. Consequently, the organization may be at a security risk possibly leading to breach of sensitive information of the organization.

### SUMMARY

The present solution generally relates to systems and methods for facilitating automated simulated phishing campaigns using newsletters. In particular, the systems and the methods relate to classifying email communications as a newsletter type of email to use in simulated phishing campaigns.

Systems and methods are provided for classifying email communications as a newsletter type of email to use in a simulated phishing communication. In an example embodiment, a method for classifying email communications as a newsletter type of email to use in a simulated phishing communication is described which includes, identifying one or more emails to classify as a newsletter type of email; classifying the one or more emails as the newsletter type of email based as least on one or more classification characteristics; modifying an email selected from the one or more emails classified as the newsletter type of email to provide a simulated phishing email newsletter; and communicating the simulated phishing email newsletter to one or more devices of one or more users.

In some implementations, the method further includes intercepting the one or more emails comprising a newsletter prior to delivery to a recipient.

In some implementations, the method further includes identifying the one or more emails comprising a newsletter stored in a storage.

In some implementations, the at least one or more classification characteristics includes one or more of the following: one or more keywords, an unsubscribe link, a sender address and an identifier of a newsletter platform.

In some implementations, the at least one or more classification characteristics includes one or more characteristics of known newsletters stored in a database.

In some implementations, the method further includes classifying, by the one or more processors, the one or more emails as malicious or not malicious.

In some implementations, the method further includes classifying the one or more emails using a newsletter score comprising a weighted function of a keyword score and one or more scores for each of the one or more classification characteristics.

In some implementations, the method further includes classifying the one or more emails as a newsletter type of email responsive the newsletter score being greater than a threshold.

In some implementations, the method further includes modifying the selected email to substitute an actionable link for a training link or to substitute an attachment with a training attachment.

In some implementations, the method further includes modifying the selected email to change one or more of the following: a body of the email, apparent or actual sender or apparent or actual recipient.

In another example embodiment, a system for classifying email communications as newsletter type of emails to use in a simulated phishing communication is described. The system configured to: identify one or more emails to classify as a newsletter type of email; classify the one or more emails as the newsletter type of email based as least on one or more classification characteristics; modify an email selected from the one or more emails classified as the newsletter type of email to provide a simulated phishing email newsletter; and communicate, the simulated phishing email newsletter to one or more devices of one or more users.

In some implementations, the system is further configured to intercept the one or more emails comprising a newsletter prior to delivery to a recipient.

In some implementations, the system is further configured to identify the one or more emails comprising a newsletter stored in a storage.

In some implementations, the at least one or more classification characteristics includes one or more of the following: one or more keywords, an unsubscribe link, a sender address and an identifier of a newsletter platform.

In some implementations, the at least one or more classification characteristics includes one or more characteristics of known newsletters stored in a database.

In some implementations, the system is further configured to classify the one or more emails as malicious or not malicious.

In some implementations, the system is further configured to classify the one or more emails using a newsletter score comprising a weighted function of a keyword score and one or more scores for each of the one or more classification characteristics.

In some implementations, the system is further configured to classify the one or more emails as a newsletter type of email responsive the newsletter score being greater than a threshold.

In some implementations, the system is further configured to modify the selected email to substitute an actionable link for a training link or to substitute an attachment with a training attachment.

In some implementations, the system is further configured to modify the selected email to change one or more of the following: a body of the email, apparent or actual sender or apparent or actual recipient.

Other aspects and advantages of the invention will become apparent from the following detailed description, taken in conjunction with the accompanying drawings, which illustrate by way of example the principles of the invention.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client devices in communication with server devices, according to some embodiments;

FIG. 1B is a block diagram depicting a cloud computing environment comprising client devices in communication with cloud service providers, according to some embodiments;

FIGS. 1C and 1D are block diagrams depicting embodiments of computing devices useful in connection with the methods and systems described herein, according to some embodiments;

FIG. 2 depicts an implementation of some of the architecture of an implementation of a system for classifying email communications as newsletter type of emails to use in a simulated phishing communication, according to some embodiments;

FIG. 3 depicts a flow chart for classifying emails as newsletter type of emails to use in a simulated phishing communication, according to some embodiments; and

FIG. 4 depicts a flow chart for classifying a newsletter type of email as malicious or not malicious to use in a simulated phishing communication, according to some embodiments.

### DETAILED DESCRIPTION

For the purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for facilitating automated simulated phishing campaigns using newsletters. In particular, the systems and the methods relate to classifying email communications as newsletter type of emails to use in the simulated phishing campaigns.

### A. Computing and Network Environment

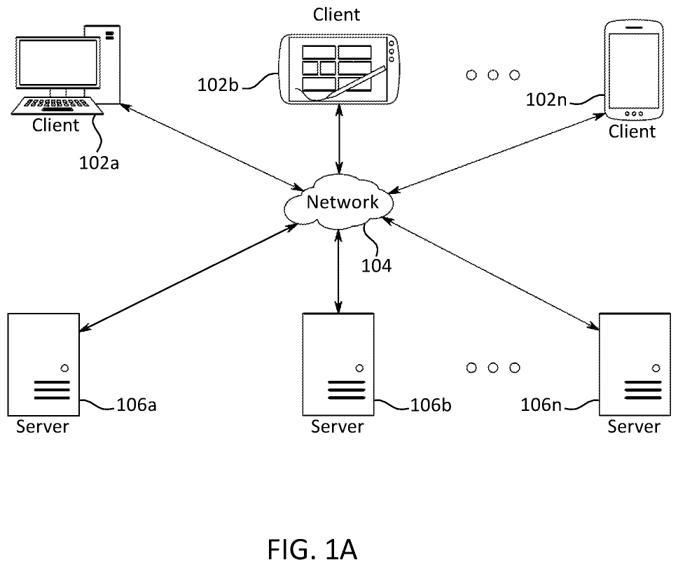

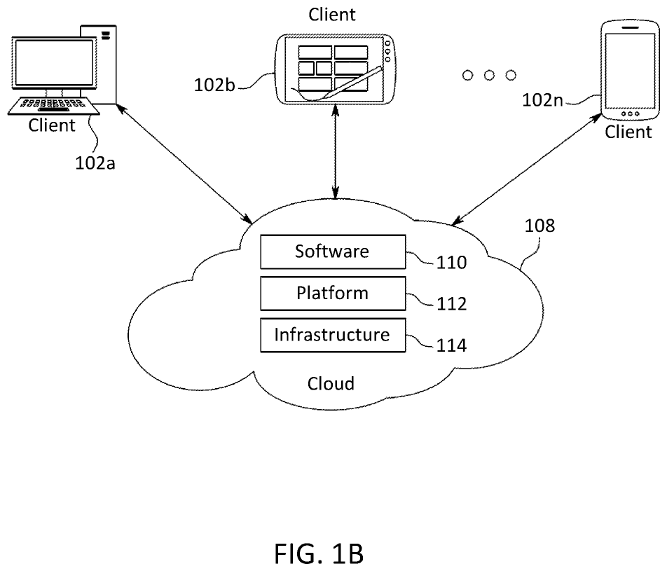

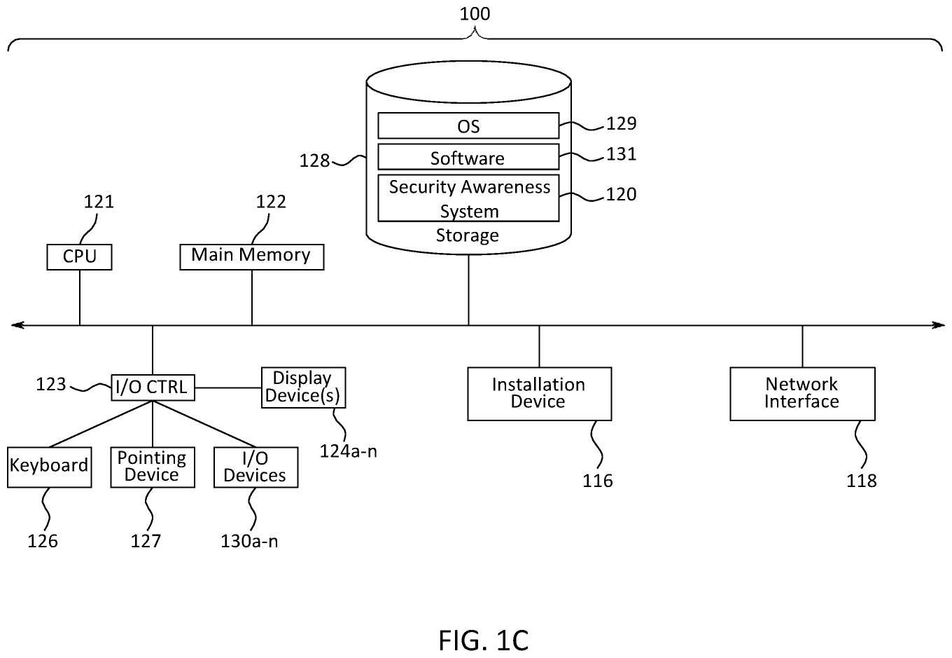

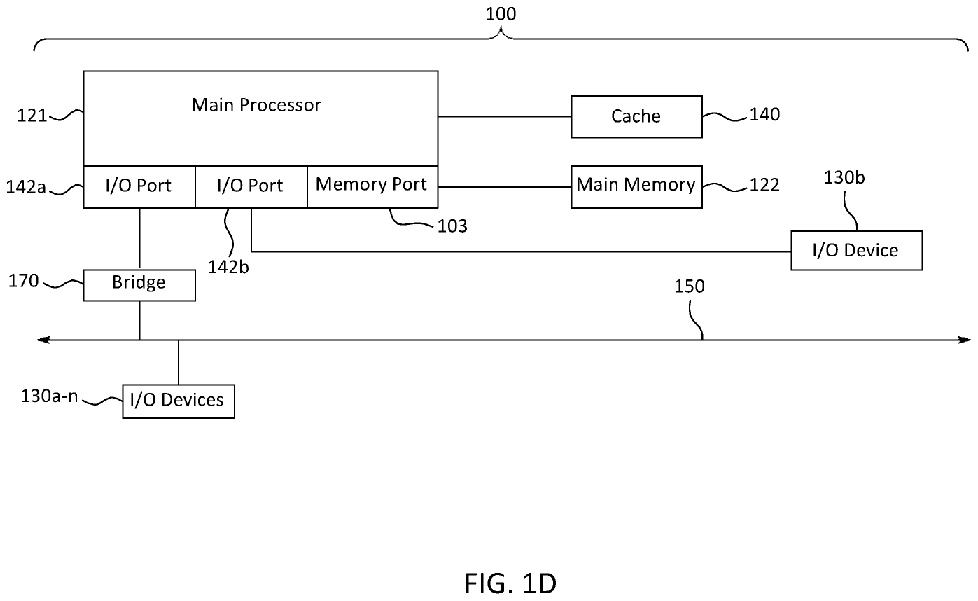

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, client 102 has the capacity to function as both a client node seeking access to resources provided by a server and as a server providing access to hosted resources for other clients 102a-102n.

Although FIG. 1A shows a network 104 between clients 102 and the servers 106, clients 102 and servers 106 may be on the same network 104. In some embodiments, there are multiple networks 104 between clients 102 and servers 106. In one of these embodiments, network 104′ (not shown) may be a private network and a network 104 may be a public network. In another of these embodiments, network 104 may be a private network and a network 104′ may be a public network. In still another of these embodiments, networks 104 and 104′ may both be private networks.

Network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

Network 104 may be any type and/or form of network. The geographical scope of the network may vary widely and network 104 can be a body area network (BAN), a personal area network (PAN), a local-area network (LAN), e.g. Intranet, a metropolitan area network (MAN), a wide area network (WAN), or the Internet. The topology of network 104 may be of any form and may include, e.g., any of the following: point-to-point, bus, star, ring, mesh, or tree. Network 104 may be an overlay network which is virtual and sits on top of one or more layers of other networks 104′. Network 104 may be of any such network topology as known to those ordinarily skilled in the art capable of supporting the operations described herein. Network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. Network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, servers 106 may be geographically dispersed. In other embodiments, a machine farm may be administered as a single entity. In still other embodiments, the machine farm includes a plurality of machine farms. Servers 106 within each machine farm can be heterogeneous—one or more of servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In the embodiment, consolidating servers 106 in this way may improve system manageability, data security, the physical security of the system, and system performance by locating servers 106 and high-performance storage systems on localized high-performance networks. Centralizing servers 106 and storage systems and coupling them with advanced system management tools allows more efficient use of server resources.

Servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif. Additional layers of abstraction may include Container Virtualization and Management infrastructure. Container Virtualization isolates execution of a service to the container while relaying instructions to the machine through one operating system layer per host machine. Container infrastructure may include Docker, an open source product whose development is overseen by Docker, Inc. of San Francisco, Calif.

Management of the machine farm may be de-centralized. For example, one or more servers 106 may comprise components, subsystems and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with cloud 108 over one or more networks 104. Clients 102 may include, e.g., thick clients, thin clients, and zero clients. A thick client may provide at least some functionality even when disconnected from cloud 108 or servers 106. A thin client or zero client may depend on the connection to cloud 108 or server 106 to provide functionality. A zero client may depend on cloud 108 or other networks 104 or servers 106 to retrieve operating system data for the client device 102. Cloud 108 may include back end platforms, e.g., servers 106, storage, server farms or data centers.

Cloud 108 may be public, private, or hybrid. Public clouds may include public servers 106 that are maintained by third parties to clients 102 or the owners of the clients. Servers 106 may be located off-site in remote geographical locations as disclosed above or otherwise. Public clouds may be connected to servers 106 over a public network. Private clouds may include private servers 106 that are physically maintained by clients 102 or owners of clients. Private clouds may be connected to servers 106 over a private network 104. Hybrid clouds 109 may include both the private and public networks 104 and servers 106.

Cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, virtualization or containerization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g. Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources using web-based user interfaces, provided by a web browser (e.g. Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e.g. Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

Client 102 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of client 102 or server 106. As shown in FIGS. 1C and 1D, each computing device 100 includes central processing unit 121, and main memory unit 122. As shown in FIG. 1C, computing device 100 may include storage device 128, installation device 116, network interface 118, and I/O controller 123, display devices 124a-124n, keyboard 126 and pointing device 127, e.g., a mouse. Storage device 128 may include, without limitation, operating system 129, software 131, and a software of security awareness system 120. As shown in FIG. 1D, each computing device 100 may also include additional optional elements, e.g., a memory port 103, bridge 170, one or more input/output devices 130a-130n (generally referred to using reference numeral 130), and cache memory 140 in communication with central processing unit 121.

Central processing unit 121 is any logic circuitry that responds to and processes instructions fetched from main memory unit 122. In many embodiments, central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. Computing device 100 may be based on any of these processors, or any other processor capable of operating as described herein. Central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTER CORE i5 and INTEL CORE i7.

Main memory unit 122 may include one or more memory chips capable of storing data and allowing any storage location to be directly accessed by microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, main memory 122 or storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. Main memory 122 may be based on any of the above described memory chips, or any other available memory chips capable of operating as described herein. In the embodiment shown in FIG. 1C, the processor 121 communicates with main memory 122 via system bus 150 (described in more detail below). FIG. 1D depicts an embodiment of computing device 100 in which the processor communicates directly with main memory 122 via memory port 103. For example, in FIG. 1D main memory 122 may be DRDRAM.

FIG. 1D depicts an embodiment in which the main processor 121 communicates directly with cache memory 140 via a secondary bus, sometimes referred to as a backside bus. In other embodiments, main processor 121 communicates with cache memory 140 using system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via local system bus 150. Various buses may be used to connect central processing unit 121 to any of I/O devices 130, including a PCI bus, a PCI-X bus, or a PCI-Express bus, or a NuBus. For embodiments in which the I/O device is video display 124, the processor 121 may use an Advanced Graphic Port (AGP) to communicate with display 124 or the I/O controller 123 for display 124. FIG. 1D depicts an embodiment of computer 100 in which main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by I/O controller 123 as shown in FIG. 1C. The I/O controller may control one or more I/O devices, such as, e.g., keyboard 126 and pointing device 127, e.g., a mouse or optical pen. Furthermore, an I/O device may also provide storage and/or installation medium 116 for computing device 100. In still other embodiments, computing device 100 may provide USB connections (not shown) to receive handheld USB storage devices. In further embodiments, a I/O device 130 may be a bridge between the system bus 150 and an external communication bus, e.g. a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, computing device 100 may include or connect to multiple display devices 124a-124n, which each may be of the same or different type and/or form. As such, any of I/O devices 130a-130n and/or the I/O controller 123 may include any type and/or form of suitable hardware, software, or combination of hardware and software to support, enable or provide for the connection and use of multiple display devices 124a-124n by computing device 100. For example, computing device 100 may include any type and/or form of video adapter, video card, driver, and/or library to interface, communicate, connect or otherwise use display devices 124a-124n. In one embodiment, a video adapter may include multiple connectors to interface to multiple display devices 124a-124n. In other embodiments, computing device 100 may include multiple video adapters, with each video adapter connected to one or more of display devices 124a-124n. In some embodiments, any portion of the operating system of computing device 100 may be configured for using multiple displays 124a-124n. In other embodiments, one or more of the display devices 124a-124n may be provided by one or more other computing devices 100a or 100b connected to computing device 100, via network 104. In some embodiments, software may be designed and constructed to use another computer's display device as second display device 124a for computing device 100. For example, in one embodiment, an Apple iPad may connect to computing device 100 and use the display of the device 100 as an additional display screen that may be used as an extended desktop. One ordinarily skilled in the art will recognize and appreciate the various ways and embodiments that computing device 100 may be configured to have multiple display devices 124a-124n.

Referring again to FIG. 1C, computing device 100 may comprise storage device 128 (e.g. one or more hard disk drives or redundant arrays of independent disks) for storing an operating system or other related software, and for storing application software programs such as any program related to security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to computing device 100 via bus 150. Some storage device 128 may be external and connect to computing device 100 via a I/O device 130 that provides an external bus. Some storage device 128 may connect to computing device 100 via network interface 118 over network 104, including, e.g., the Remote Disk for MACBOOK AIR by Apple. Some client devices 100 may not require a non-volatile storage device 128 and may be thin clients or zero clients 102. Some storage device 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Computing device 100 (e.g., client device 102) may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on client device 102. An application distribution platform may include a repository of applications on server 106 or cloud 108, which clients 102a-102n may access over a network 104. An application distribution platform may include application developed and provided by various developers. A user of client device 102 may select, purchase and/or download an application via the application distribution platform.

Furthermore, computing device 100 may include a network interface 118 to interface to network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX and direct asynchronous connections). In one embodiment, computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. Network interface 118 may comprise a built-in network adapter, network interface card, PCMCIA network card, EXPRESSCARD network card, card bus network adapter, wireless network adapter, USB network adapter, modem or any other device suitable for interfacing computing device 100 to any type of network capable of communication and performing the operations described herein.

Computing device 100 of the sort depicted in FIGS. 1B and 1C may operate under the control of an operating system, which controls scheduling of tasks and access to system resources. Computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

Computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. Computer system 100 has sufficient processor power and memory capacity to perform the operations described herein. In some embodiments, computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, computing device 100 is a gaming system. For example, the computer system 100 may comprise a PLAYSTATION 3, or PERSONAL PLAYSTATION PORTABLE (PSP), PLAYSTATION VITA, PLAYSTATION 4, or a PLAYSTATION 4 PRO device manufactured by the Sony Corporation of Tokyo, Japan, or a NINTENDO DS, NINTENDO 3DS, NINTENDO WII, NINTENDO WII U, or a NINTENDO SWITCH device manufactured by Nintendo Co., Ltd., of Kyoto, Japan, or an XBOX 360 device manufactured by Microsoft Corporation.

In some embodiments, computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, computing device 100 is a tablet e.g. the IPAD line of devices by Apple; GALAXY TAB family of devices by Samsung; or KINDLE FIRE, by Amazon.com, Inc. of Seattle, Wash. In other embodiments, computing device 100 is an eBook reader, e.g. the KINDLE family of devices by Amazon.com, or NOOK family of devices by Barnes & Noble, Inc. of New York City, N.Y.

In some embodiments, communications device 102 includes a combination of devices, e.g. a smartphone combined with a digital audio player or portable media player. For example, one of these embodiments is a smartphone, e.g. the iPhone family of smartphones manufactured by Apple, Inc.; a Samsung GALAXY family of smartphones manufactured by Samsung, Inc; or a Motorola DROID family of smartphones. In yet another embodiment, communications device 102 is a laptop or desktop computer equipped with a web browser and a microphone and speaker system, e.g. a telephony headset. In these embodiments, communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, the information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Automated Simulated Phishing Campaigns Using Newsletters

The following describes systems and methods for facilitating automated simulated phishing campaigns using newsletters. In particular, the systems and the methods relate to classifying email communications as newsletter type of emails to use in the simulated phishing campaigns.

The systems and the methods of the present disclosure leverage a security awareness system that identifies one or more newsletter type of emails and uses the one or more newsletter type of emails to create simulated phishing attacks. In an example, the one or more newsletter type of emails may be malicious or not malicious (genuine). A newsletter type of email may be malicious if the newsletter type of email includes one or more malicious elements such as malicious actionable links, malicious attachments, or any other kind of malicious element. Further, a newsletter type of email may be not malicious if the newsletter type includes one or more benign elements such as benign actionable links, benign attachments, or any other kind of benign element.

In an implementation, the security awareness system may intercept a newsletter type of email directed towards a user's mailbox to identify the newsletter type of email. In some implementations, the security awareness system may identify a newsletter type of email that a user may have already viewed or deleted from his or her mailbox. In some implementations, the security awareness system may identify a newsletter type of email that may have been routed to a user's junk folder of a mailbox. In response to identifying the newsletter type of email, the security awareness system may modify the newsletter type of email to create a simulated phishing email newsletter. In an example, the security awareness system may modify elements/contents (for example, a link and/or an attachment) of the newsletter type of email before the newsletter type of email is delivered to the user. For example, the security awareness system may substitute an actionable or an interactive link and/or an attachment of the newsletter type of email with a training link and/or a training attachment, respectively.

The security awareness system may execute a simulated phishing attack, a simulated phishing campaign or simulated phishing communications. The simulated phishing campaign may, for example, target a single user or a group of users, such as employees of a business unit of an organization for imparting cybersecurity awareness. The simulated phishing campaign may be carried out for specific purposes including identifying security awareness levels of users, updating risk scores of the users, and giving enhanced training to more vulnerable groups in the organization. In an example, the security awareness system may initiate the simulated phishing campaign based on communicating the simulated phishing email newsletter to inboxes of one or more devices of the target group of users or all users of the organization. The simulated phishing email newsletter may serve a purpose of training the users to recognize malicious newsletter emails and to gauge the security awareness of the users who interact with the simulated phishing email newsletter for further security awareness training. Accordingly, the malicious newsletter email may be detected, neutralized (made safe), and used for training the users of the organization by the security awareness system. The users are thereby educated as to security risks associated with malicious newsletter emails. Further, automatic interception and modification of the malicious newsletter email may significantly minimize the need for human intervention in generating and sending simulated phishing emails (such as simulated phishing email newsletters) to multiple users of the organization.

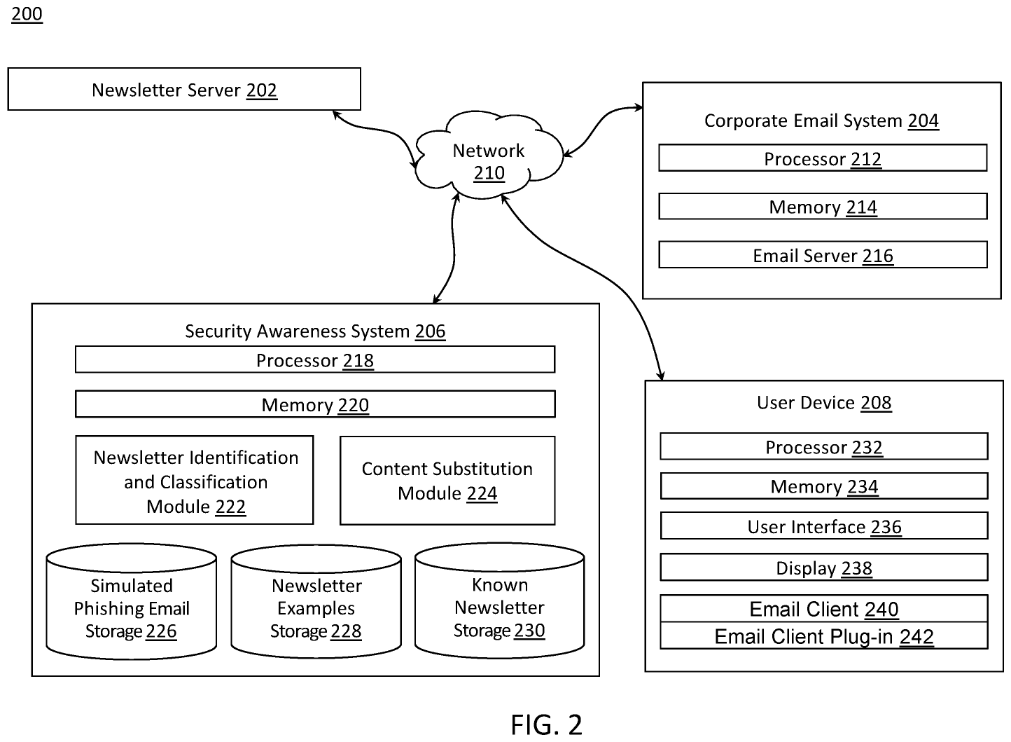

FIG. 2 depicts an implementation of some an architecture of system 200 for classifying email communications as newsletter type of emails to use in a simulated phishing communication, according to some embodiments.

System 200 may include newsletter server 202, corporate email system 204, security awareness system 206, user device 208, and network 210 enabling communication between the system components. Network 210 may be an example or instance of network 104, details of which are provided with reference to FIG. 1A and its accompanying description.

According to some embodiments, newsletter server 202 may be any server capable of exchanging information/data over network 210. In an implementation, newsletter server 202 may be a server, such as server 106 shown in FIG. 1A. Newsletter server 202 may be implemented by a device, such as computing device 100 shown in FIGS. 1C and 1D. In some embodiments, newsletter server 202 may be implemented as a part of a cluster of servers. In some embodiments, newsletter server 202 may be implemented across a plurality of servers, thereby, tasks performed by newsletter server 202 may be performed by the plurality of servers. These tasks may be allocated among the cluster of servers by an application, a service, a daemon, a routine, or other executable logic for task allocation. Known examples of newsletter server 202 include Microsoft® Exchange Server, and HCL® Domino. In an implementation, newsletter server 202 may be communicatively coupled with corporate email system 204, security awareness system 206, and user device 208 through network 210 for exchanging information.

In an implementation, newsletter server 202 may be owned or managed or otherwise associated with a third-party entity (third-party to an organization) or an external entity. In an example, the third-party entity may be either a genuine (safe) entity or a malicious entity. Newsletter server 202 may handle and deliver newsletter type of emails (interchangeably referred to as newsletter emails) to users who may have subscribed for information through the newsletter type of emails. In an example, the users may be employees of the organization. In instances where the third-party entity is a genuine entity, the newsletter type of emails sent out by newsletter server 202 may be safe and genuine. In some examples, the third-party entity may be a malicious entity sending out malicious newsletter type of emails. In an implementation, in response to a subscription by a user of user device 208, newsletter server 202 may send the newsletter type of emails to user device 208 of the user via network 210. In some implementations, newsletter server 202 may send the newsletter type of emails to user device 208 of the user without requiring any subscriptions. In an implementation, user device 208 may receive the newsletter type of emails through corporate email system 204.

According to an embodiment, corporate email system 204 may be any email handling system owned or managed or otherwise associated with an organization or any entity authorized thereof. Corporate email system 204 may be implemented in a variety of computing systems, such as a mainframe computer, a server, a network server, a laptop computer, a desktop computer, a notebook, a workstation, and the like. In an implementation, corporate email system 204 may be communicatively coupled with newsletter server 202, security awareness system 206, and user device 208 through network 210 for exchanging information. In an implementation, corporate email system 204 may be implemented in a server, such as server 106 shown in FIG. 1A. In another implementation, corporate email system 204 may be implemented by a device, such as computing device 100 shown in FIGS. 1C and 1D. In an implementation, corporate email system 204 may be configured to receive, send, and/or relay outgoing emails (for example, newsletter type of emails) between message senders (for example, newsletter server 202) and recipients (for example, security awareness system 206 and user device 208).

Corporate email system 204 may include processor 212, memory 214, and email server 216. For example, processor 212 and memory 214 of corporate email system 204 may be CPU 121 and main memory 122 respectively as shown in FIGS. 1C and 1D. In an implementation, email server 216 may be any server capable of handling and delivering emails over network 210 using one or more standard email protocols, such as Post Office Protocol 3 (POP3), Internet Message Access Protocol (IMAP), Simple Message Transfer Protocol (SMTP), and Multipurpose Internet Mail Extension (MIME) Protocol. Email server 216 may be a standalone server or a part of an email server. Email server 216 may be implemented using, for example, Microsoft® Exchange Server, and HCL Domino®. In an implementation, email server 216 may be a server 106 shown in FIG. 1A. Email server 216 may be implemented by a device, such as computing device 100 shown in FIGS. 1C and 1D. Alternatively, email server 216 may be implemented as a part of a cluster of servers. In some embodiments, email server 216 may be implemented across a plurality of servers, thereby, tasks performed by email server 216 may be performed by the plurality of servers. These tasks may be allocated among the cluster of servers by an application, a service, a daemon, a routine, or other executable logic for task allocation. In an implementation, user device 208 may receive the newsletter type of emails through email server 216 of corporate email system 204.

Referring again to FIG. 2, security awareness system 206 may be implemented in a variety of computing systems, such as a mainframe computer, a server, a network server, a laptop computer, a desktop computer, a notebook, a workstation, and the like. In an implementation, security awareness system 206 may be communicatively coupled with newsletter server 202, corporate email system 204, and user device 208 through network 210 for exchanging information. In an implementation, security awareness system 206 may be implemented in a server, such as server 106 shown in FIG. 1A. In another implementation security awareness system 206 may be implemented by a device, such as computing device 100 shown in FIGS. 1C and 1D.

In an example, security awareness system 206 may be a Computer Based Security Awareness Training (CBSAT) system that performs security services such as performing simulated phishing attacks on a user or a set of users of an organization as a part of security awareness training. Security awareness system 206 may be owned or managed or otherwise associated with the organization or a third-party entity. In an example, an email address may be associated with the security awareness system 206 such that security awareness system 206 may automatically subscribe itself to multiple newsletters in order to receive newsletters. In an implementation, a web-connected process or section of a program code (hereinafter referred to as “bot”) may be created that subscribes to as many newsletters as the bot may find, with the newsletters delivered to the email address associated with the security awareness system 206. The bot may analyze the received newsletters to identify those newsletters with are relevant to specific users (for example, based on a match of content of the newsletters with one or more known interests of the users. In an implementation, the bot may use machine learning or Artificial Intelligence (AI) techniques to determine user profile data of the users from various sources. User profile data of a user may represent one or more known interests of the user. The newsletters received by security awareness system 206 may be modified to form a part of a simulated phishing campaign. The modifications are such that the simulated phishing campaign newsletters appear similar and realistic in comparison with a newsletter type of email. In some embodiments, security awareness system 206 may register additional domains that are a doppelganger (or “look-a-like”) domain (i.e. a domain that closely resembles a real and known domain but are slightly different) to be used as part of the simulated phishing campaign. These domains may appear relevant to the subject matter of the newsletter but would in reality be used for websites that exist only as part of the simulated phishing campaign. Security awareness system 206 may use the doppelganger domains to increase apparent realism of a message by making the newsletter type of email to have originated from a real and known domain. These domains may appear relevant to the subject matter of the newsletter but would in reality be used for web sites that exist only as part of the simulated phishing campaign. The newsletters received by security awareness system 206 may provide a wide source of newsletter template material for the simulated phishing campaign. In an implementation, security awareness system 206 may operate in close coordination with corporate email system 204 such that security awareness system 206 may intercept emails sent out by corporate email system 204 before the emails are delivered to intended recipients.

Further, in some embodiments, security awareness system 206 may include processor 218 and memory 220. For example, processor 218 and memory 220 of security awareness system 206 may be CPU 121 and main memory 122 respectively as shown in FIGS. 1C and 1D. Further, security awareness system 206 may include newsletter identification and classification module 222 and content substitution module 224. In an implementation, newsletter identification and classification module 222 and content substitution module 224 may be coupled to processor 218 and memory 220. In some embodiments, newsletter identification and classification module 222 and content substitution module 224 amongst other modules, may include routines, programs, objects, components, data structures, etc., which may perform particular tasks or implement particular abstract data types. Newsletter identification and classification module 222 and content substitution module 224 may also be implemented as, signal processor(s), state machine(s), logic circuitries, and/or any other device or component that manipulate signals based on operational instructions.

In some embodiments, newsletter identification and classification module 222 and content substitution module 224 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor which executes instructions to cause the general-purpose processor to perform the required tasks or, the processing unit may be dedicated to perform the required functions. In some embodiments, newsletter identification and classification module 222 and content substitution module 224 may be machine-readable instructions which, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 220.

In an implementation, newsletter identification and classification module 222 may be configured to identify one or more emails (also referred to as email communications) to classify as a newsletter type of email. Further, newsletter identification and classification module 222 may be configured to classify the one or more emails as the newsletter type of email based on one or more classification characteristics. In an example, the at least one or more classification characteristics may include one or more of the following: one or more keywords, an unsubscribe link, a sender address and an identifier of a newsletter platform (such as, newsletter server 202). Further, content substitution module 224 may be configured to manage various aspects of a simulated phishing attack, for example, tailoring and/or executing a simulated phishing attack. A simulated phishing attack may test readiness of a user to handle phishing attacks such that malicious actions are prevented. For instance, content substitution module 224 may monitor and control timing of various aspects of a simulated phishing attack, process requests for access to attack results, and/or perform other tasks related to the management of a simulated phishing attack. According to an implementation, content substitution module 224 may be configured to modify an email selected from the one or more emails classified as the newsletter type of email by newsletter identification and classification module 222 to provide a simulated phishing email newsletter. Security awareness system 206 may further be configured to communicate the simulated phishing email newsletter to one or more devices of one or more users.

Referring back to FIG. 2, in some embodiments, security awareness system 206 may comprise simulated phishing email storage 226, newsletter examples storage 228, and known newsletter storage 230. In an implementation, simulated phishing email storage 226 may store simulated phishing email templates. Newsletter examples storage 228 may store newsletter types of emails that may have been previously delivered to users of an organization. Known newsletter storage 230 may store information related to known newsletter type of emails, such as titles of newsletters, subject fields of the known newsletter type of emails, distinctive content or layout that identifies the known newsletter type of email, dates on which the known newsletter type of emails are sent, and other details which can be used to identify emails as newsletter type of emails. In an example, known newsletter storage 230 may be developed by security awareness system 206 and managed by a system administrator of the organization. In some examples, known newsletter storage 230 may be developed by a third-party entity. The third-party entity may offer known newsletter storage 230 to security awareness system 206 as a service. Security awareness system 206 may periodically or dynamically update the simulated phishing email templates stored in simulated phishing email storage 226, the newsletter types of emails that may have been previously delivered stored in newsletter examples storage 228, and the information related to the known newsletter type of emails stored in known newsletter storage 230.

In some embodiments, user device 208 may be any device used by a user. The user may be an employee of an organization or any entity. User device 208 as disclosed, may be any computing device, such as a desktop computer, a laptop, a tablet computer, a mobile device, a Personal Digital Assistant (PDA) or any other computing device. In an implementation, user device 208 may be a device, such as client device 102 shown in FIGS. 1A and 1B. User device 208 may be implemented by a device, such as computing device 100 shown in FIGS. 1C and 1D.

According to some embodiment, user device 208 may include processor 232 and memory 234. In an example, processor 232 and memory 234 of user device 208 may be CPU 121 and main memory 122, respectively, as shown in FIGS. 1C and 1D. User device 208 may also include user interface 236 such as a keyboard, a mouse, a touch screen, a haptic sensor, voice-based input unit, or any other appropriate user interface. It shall be appreciated that such components of user device 208 may correspond to similar components of computing device 100 in FIGS. 1C and 1D, such as keyboard 126, pointing device 127, I/O devices 130a-n and display devices 124a-n. The user device 208 may also include display 238, such as a screen, a monitor connected to the device in any manner, or any other appropriate display. In an implementation, user device 208 may display a received message for the user using display 238 and is able to accept user interaction via user interface 236 responsive to the displayed message.

Referring again to FIG. 2, in some embodiments, user device 208 may include email client 240. In one example implementation, email client 240 may be an application installed on user device 208. In another example implementation, email client 240 may be an application that can be accessed over network 210 through a browser without requiring any installation on user device 208. In an implementation, email client 240 may be any application capable of composing, sending, receiving, and reading emails. For example, email client 240 may be an instance of an application, such as Microsoft Outlook™ application, Lotus Notes® application, Apple Mail® application, Gmail® application, or any other known or custom email application. In an example, a user of user device 208 may select, purchase and/or download email client 240, through for example, an application distribution platform. Note that as used herein, the term “application” may refer to one or more applications, services, routines, or other executable logic or instructions.

Email client 240 may include email client plug-in 242. In some implementations, email client plug-in 242 may not be implemented in email client 240 but may coordinate and communicate with email client 240. In some implementations, email client plug-in 242 is an interface local to email client 240 that enables email client users, i.e., recipients of emails, to select to report suspicious emails that they believe may be a threat to them or their organization. An email client plug-in may be an application program that may be added to an email client for providing one or more additional features which enables customization. The email client plug-in may be provided by the same entity that provides the email client software, or may be provided by a different entity. In an example, email client may include plug-ins providing a User Interface (UI) element such as a button to trigger a function. Functionality of email client plug-ins that use a UI button may be triggered when a user clicks the button. Some of the examples of email client plug-ins that use a button UI include but are not limited to, a Phish Alert Button (PAB) plug-in, a task create plug-in, a spam marking plug-in, an instant message plug-in and a search and highlight plug-in.

Referring back to FIG. 2, email client plug-in 242 may provide the button plug-in through which function or capabilities of email client plug-in 242 is triggered by a user action on the button. Upon activation, email client plug-in 242 may forward the email to a security contact point. Other implementations of email client plug-in 242 not discussed here are contemplated herein. In one implementation, email client plug-in 242 may be implemented in email client 240. In some implementations, email client plug-in 242 may not be implemented in email client 240 but may collaborate and communicate with email client 240. Further, in an implementation, email client 240 may communicate with email client plug-in 242 over network 210.

In operation, a user may subscribe for information to keep himself/herself abreast of updates or changes regarding a certain subject, an industry topic or related to a particular organization. In one or more embodiments, the user may subscribe for information within or outside the organization (external entities). Some non-limiting examples where users subscribe for information outside the organization include MIT Technology Review, Digital Trends, Futurism, TED, Hacker Newsletter, IT World and Institute of Electrical and Electronics Engineers (IEEE). In response to the subscriptions, external entities that manage information may communicate newsletters periodically or dynamically based on newsletter schedules to the user.

Security-conscious organizations may have measures in place to prevent cyber-attacks. In particular, the organizations may implement anti-phishing and/or anti-malware mechanisms to identify and stop phishing and malware attacks before any attacks via emails reach the users. In some instances, the anti-phishing mechanisms may not be able to stop phishing emails due to new techniques used by the phishing emails. In such instances, the organizations may rely on users to identify and report such phishing emails. In some embodiments, the anti-phishing mechanisms may allow emails that do not exhibit phishing characteristics but may look suspicious. For example, the email not exhibiting phishing characteristics from a sender or a domain (not trusted) which was not recorded by email server 216 anytime prior, may look suspicious. In instances, where the anti-phishing mechanisms have allowed emails, the anti-phishing mechanism may alert the users with a caution that the email may be a phishing email and not to open links or attachments of the email if the email is not from a known trusted source. For example, the anti-phishing mechanism may highlight some portions of the email presentation with a warning that the email may be from external sources, and links and/or attachments may not be safe to be opened. Newsletter type of emails may come under category that may or may not appear from a trusted source. In some embodiments, the anti-phishing mechanism may continue to alert for emails that are from untrusted sources or new domains.

Generally, many organizations consider the newsletter type to emails be safe as the user may have subscribed to receive these. As a result, such organizations may trust the newsletters type of emails leading to a security vulnerability. A security-conscious organization may provide security awareness training to the users to help mitigate such risks associated with potentially malicious emails such as newsletter type of emails from external entities. In some embodiments, security awareness system 206 may communicate with corporate email system 204 to identify and classify email communications as newsletter type of emails for use in a simulated phishing communication. According to an implementation, newsletter identification and classification module 222 of security awareness system 206 may identify one or more emails (also referred to as email communications) to classify as a newsletter type of email for use in the simulated phishing communication. In an example, the one or more emails may be genuine (safe) emails or malicious emails.

In some implementations, security awareness system 206 may intercept one or more emails as part of security process prior to delivery to one or more devices of the recipient(s) or users. In particular, newsletter identification and classification module 222 of security awareness system 206 may analyze the intercepted one or more emails to identify the one or more emails to classify as a newsletter type of email. In some embodiments, newsletter identification and classification module 222 may identify the one or more emails stored in a storage (such as, newsletter examples storage 228) to classify as newsletter type of emails. In an example, the emails stored in newsletter examples storage 228 may have been previously delivered to one or more users of an organization. In an implementation, newsletter identification and classification module 222 may identify the one or more emails to classify as newsletter type of emails based on monitoring the organization's email traffic. For example, newsletter identification and classification module 222 may identify the emails that arrive at inboxes or mailboxes of users of the organization periodically from a domain. Further, newsletter identification and classification module 222 may analyze the emails to determine whether such emails are newsletter type of emails. Also, newsletter identification and classification module 222 may identify the one or more emails that the users may have already viewed or deleted from their mailbox. Newsletter identification and classification module 222 may also identify the one or more emails that may have been routed to users' junk folders of the mailbox. In some implementations, newsletter identification and classification module 222 may search an inbox, a junk folder, a spam folder, a delete folder etc., of the users' mailbox to identify the one or more emails. In an implementation, newsletter identification and classification module 222 may search for the one or more emails using an Application Program Interface (API).

In some embodiments, newsletter identification and classification module 222 of security awareness system 206 may classify the one or more emails as newsletter type of emails being sent from newsletter server 202 to a recipient (user) of user device 208 prior to delivery of the one or more emails. In some embodiments, when a user of user device 208 receives an email in his or her mailbox and the user suspect the email to be potentially malicious, the user may report the email using email client plug-in 242. In an example, the user may click on the Phishing Alert Button (PAB) UI element using, for example, a mouse pointer to report the email. In an implementation, when the user reports the email as potentially malicious, email client plug-in 242 may receive an indication that the user has reported the email received at the user's mailbox or email account as potentially malicious. In response to receiving the indication that the user has reported the email as potentially malicious, email client plug-in 242 may cause email client 240 to forward the email (suspicious email) to security awareness system 206. Security awareness system 206 may classify the reported email to be a newsletter type of email and may store the newsletter type of email in newsletter examples storage 228 for further use. Further, the action of reporting the email may be used by security awareness system 206 to update a risk score of the user. In some examples, if the user accurately identifies and reports a phishing attack (malicious phishing email), the risk score of the user may go down.

In some embodiments, a functionality of the email client plug in UI element (e.g., a PAB) may be enhanced to include a newsletter checkbox. The newsletter checkbox may enable the user to mark the suspicious email as being a newsletter type of email while reporting the email. Accordingly, only newsletter type of emails may be routed to newsletter examples storage 228. In some examples, email client plug-in 242 may cause email client 240 to quarantine the reported email and route the reported email to security awareness system 206 (or a component therein, such as newsletter identification and classification module 222), thereby obviating any need for the newsletter checkbox. In an implementation, combinations of these two approaches may also be made possible, wherein the newsletter checkbox (as set by the user) is used as an additional input (along with other non-user inputs) to security awareness system 206, and security awareness system 206 may make a final classification decision.

Newsletter identification and classification module 222 may send the newsletter type of emails (or a copy thereof) to newsletter examples storage 228 and known newsletter storage 230 (if the newsletter is known). Some example techniques used by newsletter identification and classification module 222 are explained below.

In an implementation, newsletter identification and classification module 222 may classify the one or more emails as the newsletter type of emails (i.e., whether the one or more emails are newsletters or not) based at least on one or more classification characteristics. In an example, the one or more classification characteristics may include one or more of the following: one or more keywords, an unsubscribe link, one or more characteristics of known newsletters stored in a database (for example, known newsletter storage 230), a sender address, and identifier of a newsletter platform (for example, newsletter server 202).

In an implementation, newsletter identification and classification module 222 may classify an email as a newsletter type of email based on a presence of certain words and/or phrases (keywords) in the email. In an example, presence of keywords such as “Digest”, “Bulletin”, “Publication”, “Magazine”, “Journal”, “Daily”, “Weekly”, “Monthly”, and the like in the email may indicate that the email is a newsletter type of email. In some implementations, newsletter identification and classification module 222 may classify an email as a newsletter type of email based on a presence of the unsubscribe link or an OPT-OUT link in the email. In an example, an unsubscribe link may be a link that allows subscribers to opt out from receiving future emails sent by a particular entity. The unsubscribe link may usually be found in a footer of an email, at the bottom of an email or may be found elsewhere.

In some implementations, newsletter identification and classification module 222 may classify an email as a newsletter type of email based on the one or more characteristics of the known newsletters stored in the database (for example, known newsletter storage 230). In an example, known newsletter storage 230 may store characteristics and/or information related to known newsletter type of emails, such as titles of newsletters, subject fields of the known newsletter type of emails, distinctive content or layout that identifies the known newsletter type of email, dates on which the known newsletter type of emails are sent, and other details which may be used to identify emails as newsletter type of emails. In an example, newsletter identification and classification module 222 may query known newsletter storage 230 to identify the email as a newsletter type of email.

In an implementation, newsletter identification and classification module 222 may classify an email as a newsletter type of email based on a sender address of the email. Newsletter identification and classification module 222 may be configured to identify whether the email was sent (originated) by, for example, an individual, an entity, or an organization. In an example, newsletter identification and classification module 222 may determine the actual sender of the email based on to a pre-determined list of known or common newsletter senders. Newsletter identification and classification module 222 may determine a match between the actual sender and the senders on the pre-determined list. In an example, the sender address may include an email address of the sender followed by a phrase “on behalf of”. In some examples, the sender address may be a listserv address (for example, where a domain is written as “list.domain.org” or “members.domain.org”). A listserv address may be an email address that acts like a mailing list that multiple recipients subscribe to. In some examples, the sender address may include the phrase “noreply” or “donotreply”.

According to some implementations, newsletter identification and classification module 222 may classify an email as a newsletter type of email based on an identifier of a newsletter platform (for example, newsletter server 202). In an example, the identifier of the newsletter platform may be a Uniform Resource Locator (URL). Newsletter type of emails are often sent via third party platforms such as Mailchimp®. In an implementation, newsletter identification and classification module 222 may identify the email as a newsletter type of email based on analysis on whether the email has been sent via the newsletter platform. In an example, newsletter identification and classification module 222 may search for a URL of the newsletter platform to identify if the email has been sent via the newsletter platform. In some examples, newsletter identification and classification module 222 may search for email headers such as a “Return Path” or a “Reply To” to identify if the email has been sent via the newsletter platform.

In some embodiments, newsletter identification and classification module 222 may classify whether the one or more emails are a newsletter type of email based on calculating a newsletter score for each of the one or more emails. In an implementation, newsletter identification and classification module 222 may calculate the newsletter score for the one or more emails. Newsletter identification and classification module 222 may calculate the newsletter score based on a weighted function (for example, a weighted average) of the one or more classification characteristics. In an implementation, newsletter identification and classification module 222 may calculate a weighted function of a keyword score and one or more scores for each of the one or more classification characteristics. In an example, newsletter identification and classification module 222 may calculate the keyword score and the one or more scores for each of the one or more classification characteristics using equation (1) as provided below.

$$CN = {\sum }_{k = 1}^{m} \frac{{ω}_{k} \cdot {CN}_{k}}{m} \qquad ( 1 )$$

In the above equation (1), CN may represent N^{th} list of classification characteristics, where N=1 to a total number of lists, and where items in each list have a binary representation (i.e. CNₖ=1 if k^{th} characteristic is present, and CNₖ=0 if the k^{th} characteristic is absent. Each characteristic may additionally be given a weight which can be referred to as ωₖ where k=1 . . . m and ωₖ∈(0, 1] and m represents a number of characteristics in the N^{th} list

An example of a list of classification characteristics may include a keyword list. In an implementation, newsletter identification and classification module 222 may create a keyword list including pre-defined keywords. In an example, if the keyword list includes 10 keywords each having a weight of ‘Wₖ’, then newsletter identification and classification module 222 may calculate the keyword score using equation (2) provided below.

$$W = {\sum }_{k = 1}^{10} \frac{{ω}_{k} \cdot {W}_{k}}{10} \qquad ( 2 )$$

In the above equation (2), W may represent the keyword score. If each of 10 keywords have an equal weight of ‘1’ and the email has 4 keywords, then keyword score “W” will be equal to 0.4 as per equation (2). In an example, the keyword score from 0 to 1 is calculated based on a number of pre-defined keywords present in the email.

In an implementation, newsletter identification and classification module 222 may also calculate/assign scores for other classification characteristics, such as the unsubscribe link, the sender address, the identifier of the newsletter platform (such as newsletter server 202), and the one or more characteristics of known newsletters stored in the database (such as known newsletters storage 230).

According to an embodiment, newsletter identification and classification module 222 may assign the score for a classification characteristic “unsubscribe link” as ‘1’ if there is an opt-out or an unsubscribe link in the email, and as ‘0’ if the opt-out link or the unsubscribe link is not there in the email. Further, newsletter identification and classification module 222 may assign the score for a classification characteristic “sender address” based on a number of different known characteristics for the sender address for newsletters (for example, addresses that include “member” or “list”, or “no reply”). In an example, if the sender address includes any of these characteristics, newsletter identification and classification module 222 may assign the score for the classification characteristic “sender address” as ‘1’. In case, the sender address does not include any of these characteristics, newsletter identification and classification module 222 may assign the score for the classification characteristic “sender address” as ‘0’.

According to an embodiment, newsletter identification and classification module 222 may assign the score for a classification characteristic “newsletter platform” as ‘1’ if it is identified that the email has been sent via the newsletter platform and as ‘0’ if it is identified that the email has not been sent via the newsletter platform. In some embodiments, newsletter identification and classification module 222 may assign the score for a classification characteristic “known newsletter” as ‘1’ if the email is identified as a known newsletter based on known newsletters storage 230 and as ‘0’ if the email is not identified as a known newsletter based on known newsletters storage 230.

In an implementation, newsletter identification and classification module 222 may calculate the newsletter score using equation (3) as provided below.

NS=D∩P∩U∩S∩(ε_{K}·W)·(ε_{C1}·C1)· . . . (ε_{CN}·CN) (3)

In the above equation (3), NS may represent the newsletter score, D may represent the score of the classification characteristic “known newsletter”, P may represent the score of the classification characteristic “newsletter platform”, U may represent the score of the classification characteristic “unsubscribe link”, S may represent the score of the classification characteristic “sender address”, W may represent the keyword score, C1 . . . CN may represent characteristics lists, and ε_{C1} . . . ε_{CN} may represent weights associated with the characteristics lists, where εₓ∈[0,1].

According to an implementation, newsletter identification and classification module 222 may be configured to classify an email as a newsletter type of email responsive to the newsletter score being greater than a threshold (for example, a pre-determined threshold). Thus, reliability of security awareness system 206 may be improved as security awareness system 206 makes an overall classification decision based on multiple inputs, for example using a weighted average of different classification characteristics. Further, newsletter identification and classification module 222 may store the emails classified as the newsletter type of emails in newsletter examples storage 228 for future use. In an example, the emails stored in newsletter examples storage 228 may be retrieved and used as templates for new simulated phishing attacks.

In some embodiments, newsletter identification and classification module 222 may select an email from the one or more emails classified as the newsletter type of emails to use in a simulated phishing communication or a simulated phishing attack. For example, the newsletter identification and classification module may retrieve the selected email from newsletter examples storage 228. In an example, the selected email may be an email that is yet to be delivered to intended recipient(s) (for example, in case where newsletter identification and classification module 222 may have intercepted the email prior to delivery to recipient(s)). In some examples, the selected email may have been previously delivered to one or more recipients.

In an implementation, newsletter identification and classification module 222 may be further configured to classify the selected email as malicious or not malicious. In an example, the selected email may be classified as malicious if the selected email includes one or more malicious elements such as malicious actionable links, malicious attachments, or any other kind of malicious element. A malicious actionable link when accessed may invoke malicious code and/or lead to organization information being compromised. Similarly, a malicious attachment when accessed, may execute a program that performs malicious actions. In some examples, the selected email may be classified as not malicious if the selected email includes one or more benign elements such as benign actionable links, benign attachments, or any other kind of benign element. In an implementation, newsletter identification and classification module 222 may use any technique known in the art or proprietary techniques to classify the selected email as malicious or not malicious.

In some embodiments, corporate email system 204 may classify the selected email as malicious or not malicious (genuine) before the email is intercepted by security awareness system 206. In either case, i.e., whether the selected email is a genuine newsletter type of email or a malicious newsletter type of email, the selected email may be reconfigured for use in a simulated phishing communication. The manner in which the selected email may be reconfigured for use in the simulated phishing communication is described henceforth.

According to some embodiments, once the newsletter type of email has been identified and selected from the one or more emails, content substitution module 224 of security awareness system 206 may reconfigure the selected email with simulated phishing content, such as links and attachments to create a simulated phishing communication. In an implementation, content substitution module 224 may automatically modify the selected email to create/provide a simulated phishing email newsletter. The selected email may be referred to as newsletter email hereinafter. In an embodiment, content substitution module 224 may modify the newsletter email if the newsletter email is classified as malicious. In some embodiments, content substitution module 224 may modify the newsletter email irrespective of whether the newsletter email is classified as malicious or not malicious.

In an example, the newsletter email may be used as a template from which the simulated phishing email newsletter is created. In an implementation, content substitution module 224 may modify the newsletter email to substitute an actionable link of the newsletter email for a training link and/or to substitute an attachment of the newsletter email with a training attachment. In some implementations, if newsletter email includes at least two elements (malicious elements), content substitution module 224 may remove one element and may substitute other element with training material (training link or training attachment). In some implementations, content substitution module 224 may modify the newsletter email to change one or more of the following: a subject heading of the email, a body of the email, apparent or actual sender or apparent or actual recipient of the email.

In some embodiments, content substitution module 224 may modify (substitute) the actionable link (which may be a benign link or a malicious link) of the newsletter email to provide the simulated phishing email newsletter to include the training link that, when interacted with, may direct a user to training content, for example, a landing page hosted by security awareness system 206. The training link may be made to look the same or very similar to the actionable link in the newsletter email. In an example, a landing page may be understood as a page that a user is traversed to if the user fails a simulated phishing attack, that is if the user interacts in some way with the training link of the simulated phishing email newsletter. In an example, a landing page may be any page which enables provisioning of training materials. For example, the landing page may be a web page or an element of a web page such as a pop-up which enables provisioning of the training materials. A pop-up may be understood to refer to the appearance of graphical or textual content on a display. In some examples, the landing page may provide training related to potential security risks that a user could have entailed if the training link was a malicious link. The landing page may also include suggestions and/or tips for reducing risks in future.

In an implementation, content substitution module 224 may substitute the attachment (which may be a benign attachment or a malicious attachment) of the newsletter email with the training attachment to provide the simulated phishing email newsletter. In an example, the attachment may include a discount flyer Portable Document Format (PDF) file for a convention or a conference. In an implementation, content substitution module 224 may replace the attachment with the training attachment that may redirect a user to a landing page for security awareness training when the user attempts to either save, open, or run the attachment. In an example, the training attachment may include a notification message that provides training material related to security awareness. In some examples, the training attachment may include one or more links to the training material. In a scenario where the newsletter email includes a PDF attachment or a Hypertext Markup Language (HTML) attachment, content substitution module 224 may identify such types of attachments and may not substitute image files present (if any) in the attachment as changes to graphical (image) content may alert the user.

Further, content substitution module 224 may modify a subject heading of the newsletter email to provide the simulated phishing email newsletter. In an implementation, content substitution module 224 may automatically modify the subject heading of the newsletter email based on a pre-determined list of alternative headings. Content substitution module 224 may select an alternative heading from the pre-determined list of alternative headings. In an example, content substitution module 224 may randomly select the alternative heading from the pre-determined list of alternative headings. In some examples, content substitution module 224 may select the alternative heading based on contextual information derived from the newsletter email such as keywords, a source of the newsletter email, or a recipient of the newsletter email. In some implementations, content substitution module 224 may modify the subject heading of the newsletter email based on the output of a Natural Language Processing (NLP) engine. In example, content substitution module 224 may use the NPL engine to analyze text of the newsletter email and generate appropriate subject headings. In an example, users may be accustomed to receiving newsletter emails with certain headings or keywords. However, substituting a subject heading for one that the users are not familiar with may provide a good test as to whether the users are sufficiently cautious of interacting with the newsletter email. In some examples, the subject heading could be changed as a part of a general attempt to create the simulated phishing email newsletter on a new topic by using an original newsletter email (on a different topic) as a template.

In some embodiments, content substitution module 224 may automatically change a portion or full body of the newsletter email to provide the simulated phishing email newsletter. In an example, some of the body text of the newsletter email may be modified to create the simulated phishing email newsletter on a new topic by using the original newsletter email as a template. In an implementation, content substitution module 224 may modify the body of the newsletter email based on a pre-determined list of alternative body text. Content substitution module 224 may select an alternative body text from the pre-determined list of alternative body text. In an example, content substitution module 224 may randomly select the alternative body text from the pre-determined list of alternative body text. In some examples, content substitution module 224 may select the alternative body text based on contextual information derived from the newsletter email such as keywords, a source of the newsletter email, or a recipient of the newsletter email. In some implementations, content substitution module 224 may change a portion of or full body of the newsletter email based on the NLP engine. In example, content substitution module 224 may use the NLP engine to analyze text of the newsletter email and generate appropriate body text.

In an implementation, content substitution module 224 may change/alter the actual sender or actual recipient(s) of the newsletter email to provide the simulated phishing email newsletter. In a Simple Mail Transfer Protocol (SMTP) protocol, an actual sender and actual recipient(s) of an email may be established in an SMTP envelope portion of the email. In an example, content substitution module 224 may use an SMTP MAIL command to establish the actual sender of the newsletter email. Further, content substitution module 224 may use an SMTP RCPT command to establish actual recipient(s) of the newsletter email. Upon establishing the actual sender and the actual recipient(s) of the newsletter email, content substitution module 224 may change the actual sender and/or the actual recipient(s).

In some embodiments, content substitution module 224 may change/alter apparent sender or apparent recipient(s) of the newsletter email to provide the simulated phishing email newsletter. In the SMTP protocol, fields within a header portion of an email (conveyed as a part of an SMTP DATA command) are used to represent a sender (for example, “From:” field) and recipient(s) (for example, “To:” or “Cc:” fields). However, as may be understood, the apparent sender or the apparent recipient(s) (as conveyed by the SMTP DATA command) may not be aligned with the actual sender or the actual recipient(s) (as conveyed by the SMTP MAIL and RCPT commands). The apparent sender or the apparent recipient(s) may instead be intentionally misaligned with the actual sender or the actual recipient(s). This may increase the simulated phishing email newsletter's effectiveness as a training tool as there may be an increased likelihood that recipient(s) interacts or responds to such newsletter emails.

In an implementation, content substitution module 224 may analyze content of the newsletter email and select a domain name (for the apparent sender) that best matches the content of the newsletter email. In an example, content substitution module 224 may select a domain name “@doggies.com” for a newsletter email related to a dog owner. In another example, content substitution module 224 may select a domain name “@robotics-for-industry.com” for a newsletter email related to a simulated technology circular on robotics for factory automation. Based on this approach, the simulated phishing email newsletter may appear to originate from the same email address as the original newsletter email (via the “From:” field in the SMTP DATA command). This may increase the likelihood that recipient(s) of the simulated phishing email newsletter may interact or respond to simulated phishing email newsletter.

As may be understood, effectiveness of simulated phishing attacks for security awareness training may be enhanced through the use of simulated phishing emails that appear highly realistic and may have particular relevance to a user. Realistic and relevant simulated phishing email may increase a likelihood of the user interacting with the simulated phishing email. In some examples, content substitution module 224 may intelligently select topics or content of the simulated phishing email newsletter to make the simulated phishing email newsletter appear more relevant to a user (for example, to align with a known interest of the user). In an example, content substitution module 224 may use artificial intelligence or machine learning techniques to identify the topics of relevance or interest to a given user. To identify the topics of relevance or interest to a given user, such techniques may analyze the profile of the user, such as demographics of the user, interests of the user, an organization that the user is a part of, email history of the user, blog history of the user, educational and employment history of the user, newsletters that the user has subscribed to, social media accounts, and so forth.

Once the topics of interest to the user are identified, content substitution module 224 may change/modify the subject heading, the body text, and/or or any other content of the original newsletter email to align with the topics of relevance to the user. In an example, if a topic of interest to a user is identified as “motorsport”, then content substitution module 224 may modify content of a newsletter email based on this topic. For example, content substitution module 224 may change the subject heading to “Racing Newsletter” and insert text from recent racing headlines. Content substitution module 224 may also alter the apparent sender (in the “From:” field in of the SMTP DATA command) to read “donotreply@fastcars.com”.

According to some embodiments, security awareness system 206 may execute a simulated phishing attack or a simulated phishing campaign based on the one or more emails classified as a newsletter type of email. The simulated phishing campaign may, for example, target a group of users, such as employees of a business unit of the organization for imparting cybersecurity awareness. The simulated phishing campaign may be carried out for specific purposes including giving enhanced training to more vulnerable groups in the organization. In an example, security awareness system 206 may initiate the simulated phishing campaign based on communicating the simulated phishing email newsletter to one or more devices of one or more users of the organization. In an example, content substitution module 224 may communicate the simulated phishing email newsletter to the one or more devices of the one or more users of the organization. In an example, content substitution module 224 may send the simulated phishing email newsletter to one or more devices of the users with poor risk scores or users with a risk score that is above a pre-determined threshold (due to lack of cyber security awareness). A risk score of a user may be a representation of vulnerability of the user to a malicious attack. The higher the risk score, the higher the vulnerability of the user to a malicious attack.

According to some embodiments, users who interact with the simulated phishing email newsletter may be immediately provided with training on the phishing attack. In an implementation, on receiving the simulated phishing email newsletter, if a user interacts with the training link or the training attachment of the simulated phishing email newsletter in any way, the user may be traversed to (or presented with) a specific landing page. For example, the user may be traversed to the landing page when the user clicks on the training link in the simulated phishing email newsletter. The landing page may alert the user that the user has failed a simulated phishing test and provide general or specific learning materials to the user. In an example, if the user interacts with the training link and/or the training attachment of the simulated phishing email newsletter, a risk score of the user may go up. In some implementations, if the user reports the simulated phishing email newsletter as a suspicious, a risk score of the user may go down. In an implementation, the user may be suitably and publicly rewarded for reporting the simulated phishing email newsletter as a suspicious. Such rewards may motivate other users to improve their security awareness.

Accordingly, the simulated phishing email newsletter may serve a purpose of training for the users of the organization to recognize a security threat associated with malicious newsletter type of emails and also to gauge the security awareness of the users who interact with training links and/or the training attachments of the simulated phishing email newsletter for further training. As a result, the organization effectively mitigates the threat of the malicious newsletter type of emails and a risk of damage to the organization is minimized.

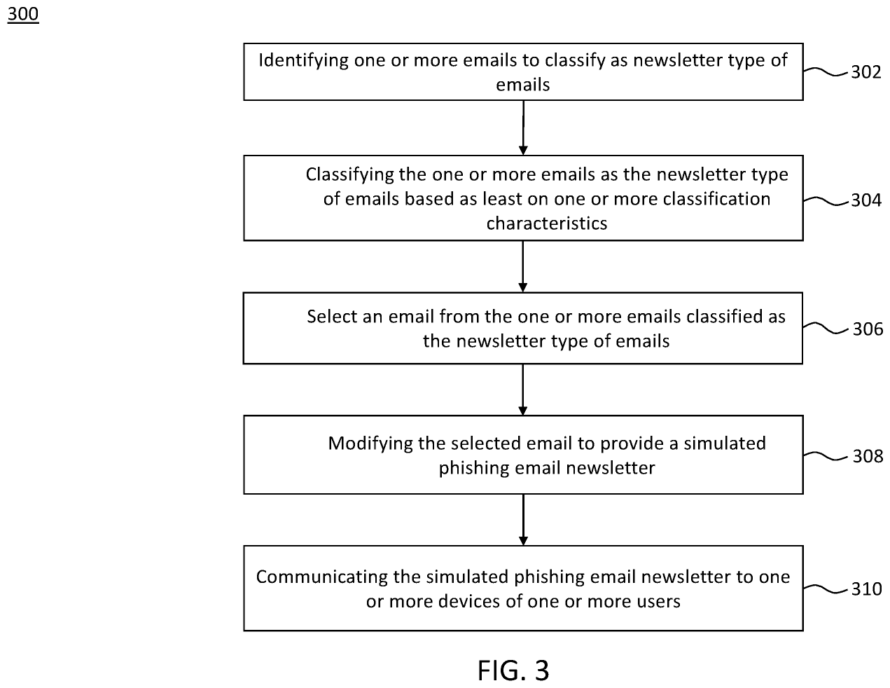

FIG. 3 depicts a flow chart 300 for classifying emails as newsletter type of emails to use in a simulated phishing communication, according to some embodiments.

Step 302 includes identifying one or more emails to classify as newsletter type of emails. In an implementation, security awareness system 206 (or a component therein, such as newsletter identification and classification module 222) may identify the one or more emails to classify as newsletter type of emails. In an example, security awareness system 206 may intercept the one or more emails comprising a newsletter prior to delivery to a recipient. In some implementations, security awareness system 206 may identify the one or more emails comprising the newsletter stored in a storage (for example, known newsletter storage 230). In an implementation, security awareness system 206 may intercept the one or more emails directed towards a user's mailbox prior to delivery of the one or more emails to the user. In an example, security awareness system 206 may operate in close coordination with corporate email system 204 such that security awareness system 206 may intercept the one or more emails sent out by corporate email system 204 before the one or more emails are delivered to intended recipient (in this case, the user). In some implementations, the security awareness system 206 may identify the one or more emails that users may have already viewed or deleted from their mailbox. In some implementations, the security awareness system 206 may identify the one or more emails routed to users' junk folder of mailbox.

Step 304 includes classifying the one or more emails as the newsletter type of emails based at least on one or more classification characteristics. In an implementation, security awareness system 206 (or a component therein, such as newsletter identification and classification module 222) may classify the one or more emails as the newsletter type of emails based at least on one or more classification characteristics. In an example, the one or more classification characteristics may include one or more of the following: one or more keywords, an unsubscribe link, one or more characteristics of known newsletters stored in a database (for example, known newsletter storage 230), a sender address, and an identifier of a newsletter platform (for example, newsletter server 202). In an implementation, security awareness system 206 may classify the one or more emails using a newsletter score including a weighted function of a keyword score and one or more scores for each of the one or more classification characteristics. Security awareness system 206 may classify the one or more emails as a newsletter type of email responsive to the newsletter score being greater than a threshold.

Step 306 includes selecting an email from the one or more emails classified as the newsletter type of emails. In an implementation, security awareness system 206 (or a component therein, such as newsletter identification and classification module 222) may select the email from the one or more emails classified as the newsletter type of emails to use in a simulated phishing communication or a simulated phishing attack.

Step 308 includes modifying the selected email to provide a simulated phishing email newsletter. In an implementation, security awareness system 206 (or a component therein, such as content substitution module 224) may modify the selected email to substitute an actionable link of the selected email for a training link and/or to substitute an attachment of the selected email with a training attachment to create the simulated phishing email newsletter. In an example, the actionable link may be a malicious actionable link and the attachment may be a malicious attachment. In some examples, the actionable link may be a benign actionable link and the attachment may be a benign attachment.

Step 310 includes communicating the simulated phishing email newsletter to one or more devices of one or more users. In an implementation, security awareness system 206 (or a component therein, such as content substitution module 224) may communicate the simulated phishing email newsletter to one or more devices of one or more users for imparting security awareness training to the one or more users.

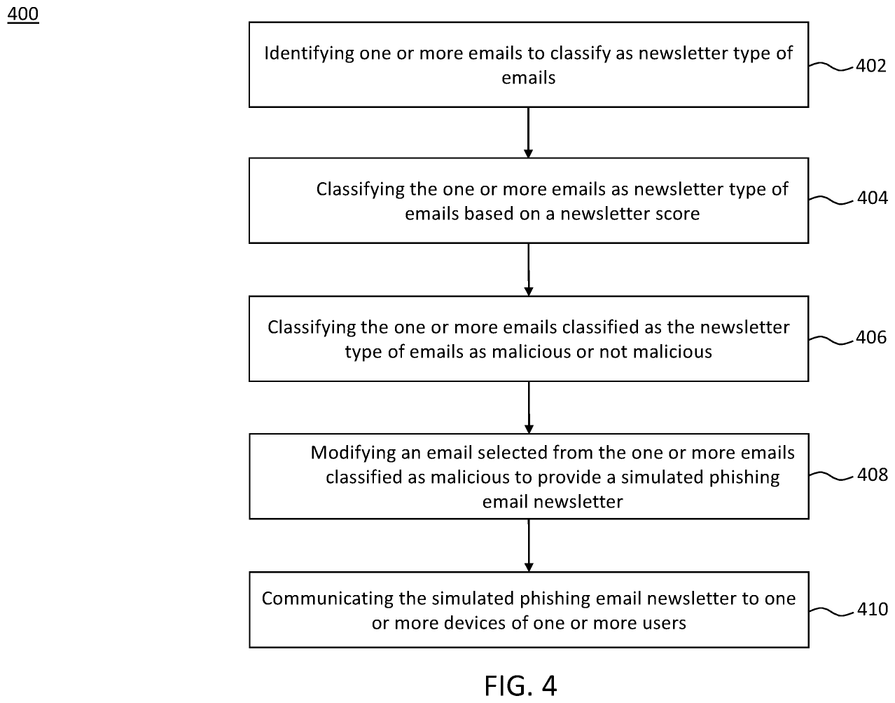

FIG. 4 depicts a flow chart 400 for classifying a newsletter type of email as malicious or not malicious to use in a simulated phishing communication, according to some embodiments.

Step 402 includes identifying one or more emails to classify as newsletter type of emails. In an implementation, security awareness system 206 (or a component therein, such as newsletter identification and classification module 222) may identify the one or more emails to classify as newsletter type of emails.

Step 404 includes classifying the one or more emails as the newsletter type of emails based on a newsletter score. In an implementation, security awareness system 206 may classify the one or more emails using the newsletter score including a weighted function of a keyword score and one or more scores for each of one or more classification characteristics. In an example, the one or more classification characteristics may include one or more of the following: one or more keywords, an unsubscribe link, one or more characteristics of known newsletters stored in a database (for example, known newsletter storage 230), a sender address, and an identifier of a newsletter platform (for example, newsletter server 202). In an implementation, security awareness system 206 may classify the one or more emails as newsletter type of emails responsive to the newsletter score being greater than a threshold.

Step 406 includes classifying the one or more emails classified as the newsletter type of emails as malicious or not malicious. In an implementation, security awareness system 206 (or a component therein, such as newsletter identification and classification module 222) may classify the one or more emails as malicious or not malicious. In an example, an email may be classified as malicious if the email includes one or more malicious elements such as malicious actionable links, malicious attachments, or any other kind of malicious element. A malicious actionable link when accessed may invoke malicious code and/or lead to organization information being compromised. Similarly, a malicious attachment when accessed, may execute a program that performs malicious actions. In some examples, an email may be classified as not malicious if the email includes one or more benign elements such as benign actionable links, benign attachments, or any other kind of benign element.

Step 408 includes modifying an email selected from the one or more emails classified as malicious to provide a simulated phishing email newsletter. In an implementation, security awareness system 206 (or a component therein, such as content substitution module 224) may modify the email selected from one or more emails classified as malicious to provide the simulated phishing email newsletter. In an example, security awareness system 206 may substitute an actionable link of the selected email for a training link and/or to substitute an attachment of the selected email with a training attachment to create the simulated phishing email newsletter. In an example, the actionable link may be a malicious actionable link and the attachment may be a malicious attachment.

Step 410 includes communicating the simulated phishing email newsletter to one or more devices of one or more users. In an implementation, security awareness system 206 (or a component therein, such as content substitution module 224) may communicate the simulated phishing email newsletter to one or more devices of one or more users for imparting security awareness training to the one or more users.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for classifying email communications as a newsletter type of emails to use in a simulated phishing communication, the method comprising:
(a) identifying, by one or more processors, one or more emails to classify as a newsletter type of email;
(b) classifying, by the one or more processors, the one or more emails as the newsletter type of email based at least on one or more classification characteristics.
(c) modifying, by the one or more processors, an email selected from the one or more emails classified as the newsletter type of email to provide a simulated phishing email newsletter; and
(d) communicating, by the one or more processors, the simulated phishing email newsletter to one or more devices of one or more users.

2. The method of claim 1, wherein (a) further comprises intercepting, by the one or more processors, the one or more emails comprising a newsletter prior to delivery to a recipient.

3. The method of claim 1, wherein (a) further comprises identifying, by the one or more processors, the one or more emails comprising a newsletter stored in a storage.

4. The method of claim 1, wherein the at least one or more classification characteristics comprises one or more of the following: one or more keywords, an unsubscribe link, a sender address and an identifier of a newsletter platform.

5. The method of claim 1, wherein the at least one or more classification characteristics comprises one or more characteristics of known newsletters stored in a database.

6. The method of claim 1, wherein (b) further comprising classifying, by the one or more processors, the one or more emails as malicious or not malicious.

7. The method of claim 1, wherein (b) further comprising classifying, by the one or more processors, the one or more emails using a newsletter score comprising a weighted function of a keyword score and one or more scores for each of the one or more classification characteristics.

8. The method of claim 7, further comprising classifying, by the one or more processors, the one or more emails as a newsletter type of email responsive the newsletter score being greater than a threshold.

9. The method of claim 1, wherein (c) further comprises modifying, by the one or more processors, the selected email to substitute an actionable link for a training link or to substitute an attachment with a training attachment.

10. The method of claim 1, wherein (c) further comprises modifying, by the one or more processors, the selected email to change one or more of the following: a body of the email, apparent or actual sender or apparent or actual recipient.

11. A system for classifying email communications as a newsletter type of emails to use in a simulated phishing communication, the system comprising:
one or more processors, coupled to memory, and configured to:
identify one or more emails to classify as a newsletter type of email;
classify the one or more emails as the newsletter type of email based as least on one or more classification characteristics;
modify an email selected from the one or more emails classified as the newsletter type of email to provide a simulated phishing email newsletter; and
communicate, the simulated phishing email newsletter to one or more devices of one or more users.

12. The system of claim 11, wherein the one or more processors are further configured to intercept the one or more emails comprising a newsletter prior to delivery to a recipient.

13. The system of claim 11, wherein the one or more processors are further configured to identify the one or more emails comprising a newsletter stored in a storage.

14. The system of claim 11, wherein the at least one or more classification characteristics comprises one or more of the following: one or more keywords, an unsubscribe link, a sender address and an identifier of a newsletter platform.

15. The system of claim 11, wherein the at least one or more classification characteristics comprises one or more characteristics of known newsletters stored in a database.

16. The system of claim 11, wherein the one or more processors are further configured to classify the one or more emails as malicious or not malicious.

17. The system of claim 11, wherein the one or more processors are further configured to classify the one or more emails using a newsletter score comprising a weighted function of a keyword score and one or more scores for each of the one or more classification characteristics.

18. The system of claim 17, wherein the one or more processors are further configured to classify the one or more emails as a newsletter type of email responsive the newsletter score being greater than a threshold.

19. The system of claim 11, wherein the one or more processors are further configured to modify the selected email to substitute an actionable link for a training link or to substitute an attachment with a training attachment.

20. The system of claim 11, wherein the one or more processors are further configured to modify the selected email to change one or more of the following: a body of the email, apparent or actual sender or apparent or actual recipient.
